(19) United States
(12) Patent Application Publication
(10) Pub. No.: US 2026/0031526 A1
(43) Pub. Date: Jan. 29, 2026

(54) Compact Loaded Semi-Loop antenna for Hearing Devices

(71) Applicant: SONOVA AG, Staefa (CH)

(72) Inventor: Jaafar Hussein, Fribourg (CH)

(21) Appl. No.: 19/273,549

(22) Filed: Jul. 18, 2025

(30) Foreign Application Priority Data
Jul. 29, 2024 (EP) 24191539.6

(51) Int. Cl. H01Q 1/27

(52) U.S. Cl. CPC H01Q 1/273

(57) ABSTRACT

There is provided a transmission system for a body-worn electronic device, comprising a U-shaped first antenna element comprising a first arm portion and a second arm portion connected by a central portion configured to be connected to a transceiver for feeding an RF signal to the first antenna element, each arm portion comprising a free end portion; and a second antenna element extending in a transverse direction between the free end portion of the first arm portion and the free end portion of the second arm portion, the second antenna element having a first end coupled to the free end portion of the first arm portion via a first capacitive region, and having a second end coupled to the free end portion of the second arm portion via a second capacitive region.

### RELATED APPLICATIONS

The present application claims priority to EP Patent Application No. 24191539.6, filed Jul. 29, 2024, which is hereby incorporated by reference in its entirety.

### BACKGROUND INFORMATION

The recent evolution in wireless wearables imposes a need for more reliable and efficient communication between connected devices. One area of interest for wireless wearables are hearing devices, where establishing an ear-to-ear and/or ear-to-remote communication is required. Typically, such communication is established in the 2.4 GHz ISM band via the Bluetooth protocol or proprietary protocols. At 2.4 GHz, the free space wavelength λ0 is around 12.5 cm. However, the volume allocated for an antenna inside a hearing device is relatively limited where the dimensions are less than λ0/10. In such a context, compact electrically small antennas should be integrated inside the hearing device. However, a small antenna size imposes constraints concerning performance in terms of radiation efficiency, bandwidth, and radiation pattern, while antenna performance becomes a critical parameter to take into account in order to insure a reliable communication between the devices inside the network.

US 2019/00987420 A1 relates to an antenna in or on an enclosure of an ear worn device, wherein a single reactive component, such as a capacitor, couples two free ends of the antenna which are bent relatively close together.

US 2023/0133627 A1 relates to an antenna for a BTE (behind-the-ear) hearing aid, wherein a U-shaped parasitic element is located in the housing above two driven parallel antenna plates connected by a bridge element, and wherein the parasitic element is substantially parallel to the edges of the plates and the bridge element.

US 2020/0091592 A1 and US 2020/0015023 A1 relate to examples of antennas for BTE hearing aids, wherein the antenna has two spaced apart free ends without a parasitic element in between.

US 2012/0266019 A1 relates to a loop antenna for a hearing device including a plurality of conductors connected in series by inductors and capacitors so as to increase the electrical length of the antenna.

### BRIEF DESCRIPTION OF THE DRAWINGS

Hereinafter, examples of the invention will be illustrated by reference to the attached drawings, wherein:

FIG. 1 is a perspective view of an example of a BTE hearing device comprising an example of a transmission system;

FIG. 2 is a perspective view of the antenna of the transmission system of FIG. 1 in a folded condition before being mounted;

FIG. 3 is an enlarged view of the feeding region of the first antenna element of the antenna of FIG. 2;

FIG. 4 is an enlarged view of a capacitive region formed between the first antenna element and the second antenna element of the antenna of FIG. 2;

FIG. 5 is a top view of the antenna of FIG. 2 in an unfolded planar condition;

FIG. 6 is a schematic illustration of a more general principle underlying the example of the antenna FIG. 5;

FIG. 7 shows a variant of the capacitive region shown in FIG. 4;

FIGS. 8A-C show further variants of the capacitive region shown in FIG. 4;

FIGS. 9A-D illustrate variants of how the first and second antenna elements may be implemented on a PCB and/or a housing; and

FIGS. 10A and B illustrate variants of where the antenna may be positioned in the hearing device of FIG. 1.

### DETAILED DESCRIPTION

Described herein are a transmission system for a body-worn electronic device, such as a hearing instrument, comprising an antenna.

It is a feature described herein to provide for a transmission system for a body-worn electronic device which has a compact and relatively easy to manufacture design, while providing for acceptable radiation performance, in particular in terms of the antenna gain.

Solutions described herein are beneficial in that, by providing a driven U-shaped first antenna element and a second antenna element extending in a transverse direction between the free end portions of the first antenna element and coupled to the free end portions via respective capacitive regions, a compact design without a need for integrated lumped loads, such as capacitors, can be achieved, wherein the second antenna element may act as a capacitive load for creating self-resonance within a desired frequency band.

According to one embodiment, the first antenna element and the second antenna element are implemented as conductor traces on a PCB. In particular, the first and/or second antenna element may be implemented by a continuous conductor trace without interruptions. For example, the conductor traces forming the first antenna element and the second antenna element may have a thickness between 12 and 70 μm and may have a width between 0.5 and 1.5 mm. Further, the PCB may be a flexible PCB and the respective parts of the PCB carrying the arm portions of the first antenna element and the ends of the second antenna element may be configured to be folded by an angle of 80 to 100 degrees relative to the part of the PCB carrying the central portion of the first antenna element.

According to one embodiment, the width of each arm portion increases at its free end portion so as to provide for a projection facing the free end portion of the other arm portion, thereby forming a corner region at each free end portion. In particular, each of the projections may extend by 0.10 to 0.50 mm from the respective arm portion into the transverse direction towards the other arm portion. For example, the first end of the second antenna element may extends in the transverse direction into the corner region formed at the free end portion of the first arm portion, thereby forming the first capacitive region, and the second end of the second antenna element may extend in the transverse direction into the corner region formed at the free end portion of the second arm portion, thereby forming the second capacitive region. Further, a width of a gap formed between the free end portion of the first arm portion and the first end of the second antenna element and a width of a gap formed between the free end portion of the second arm portion and the second end of the second antenna element, respectively, may be from 0.17 to 0.37 mm in the transverse direction. For example, a width of a gap formed between the free end portion of the first arm portion and the first end of the second antenna element and a width of a gap formed between the free end portion of the second arm portion and the second end of the second antenna portion, respectively, may be from 0.07 to 0.27 mm in a longitudinal direction perpendicular to the transverse direction.

According to one embodiment, each arm portion of the first antenna element includes an intermediate portion which extends between the central portion and the free end portion and which is angled, such as at an angle of 30 to 60 degrees, relative to the central portion, wherein the free end portions are oriented substantially parallel to each other and substantially perpendicular to the central portion. In particular, a corner of the first end of the second antenna element facing the intermediate portion of the first arm portion may be cut away, wherein a corner of the second end of the second antenna element facing the intermediate portion of the second arm portion may be cut away. For example, the corner of the first end of the second antenna element facing the intermediate portion of the first arm portion may be cut away along a line substantially parallel to the intermediate portion of the first arm portion, wherein the corner of the second end of the second antenna element facing the intermediate portion of the second arm portion may be cut away along a line substantially parallel to the intermediate portion of the second arm portion. Further, a width of a gap between the cut-away corner of the first end of the second antenna element and the intermediate portion of the first arm portion and a width of a gap between the cut-away corner of the second end of the second antenna element and the intermediate portion of the second arm portion, respectively, may be from 0.33 to 0.63 mm.

Further, the free end portions of the first arm portion and the second arm portion, respectively, may have a length of 1.8 to 3.8 mm, and the intermediate portions of the first arm portion and the second arm portion, respectively, may have a length of 2.9 to 6.9 mm.

For example, the central portion of the first antenna element may have a length of 12 to 20 mm.

For example, the central portion of the first antenna element may be oriented substantially parallel to the second antenna element. In particular, a distance between the central portion of the first antenna element and the second antenna element may be from 1 to 3 mm in a longitudinal direction perpendicular to the transverse direction.

For example, a distance between the free end portions of the arm portions may be from 15 to 25 mm.

For example, a dimension of the first antenna element in a longitudinal direction perpendicular to the transverse direction may be from 3 to 7 mm.

According to one embodiment, the central portion of the first antenna element comprises two feeding points, separated by a gap, for feeding a differential RF signal as said RF signal to the first antenna element. In particular, the central portion of the first antenna element may comprise an inductive region formed by a shorting strip which shorts the gap formed in the central portion between the two feeding points. For example, the shorting strip may be substantially arc-shaped, and it may have a width between 0.1 mm and 1.0 mm. Further, the gap formed in central portion of the first antenna element may have a width of 0.1 to 1.0 mm.

According to one example, the second antenna element may be designed to act as a capacitive load.

According to one embodiment, the second antenna element may be substantially strip-shaped. In particular, a ratio of a length of the second antenna element to a width of the second antenna element is from 5 to 25. For example, the length of the second antenna element is from 15 to 25 mm, and the width of the second antenna element may be from 0.5 to 3.0 mm. For example, the second antenna element may comprise a central portion which is offset in a longitudinal direction perpendicular to the transverse direction, such as by 0.5 to 1.5 mm, with regard to the first and second end of the second antenna element.

According to one embodiment, the transmission system comprises a transceiver connected to the central portion for feeding an RF signal to the first antenna element. In particular, the transceiver may be configured to operate in the 2.4 GHz ISM band.

According to one embodiment, the first antenna element is printed on a housing of the electronic device, such as by Laser Direct Structuring.

According to one embodiment, the second antenna element is printed on a housing of the electronic device, such as by Laser Direct Structuring.

According to one embodiment, one of the free end portion of the first arm portion and the first end of the second antenna portion is elevated relative to the other, with the free end portion of the first arm portion and the first end of the second antenna portion defining an overlap region with plate-like gap forming the first capacitive region, and wherein one of the free end portions of the second arm portion and the second end of the second antenna portion is elevated relative to the other, with the free end portion of the second arm portion and the second end of the second antenna portion defining an overlap region with plate-like gap forming the second capacitive region.

According to one embodiment, the free end portion of the first arm portion and the first end of the second antenna portion are oriented substantially parallel to each other, thereby forming an elongate rectangular gap extending in the longitudinal direction as the first capacitive region, and wherein the free end portion of the second arm portion and the second end of the second antenna portion are oriented substantially parallel to each other, thereby forming an elongate rectangular gap extending in the longitudinal direction as the second capacitive region.

Features described herein also relate to a hearing device comprising a transmission system. In particular, the hearing device may be an ITE (in the ear) hearing device, an RIC (receiver in the canal) hearing device, a BTE (behind the ear) hearing device or a sound processor of a cochlear implant, a wireless headset, an earbud, an earplug, or an earphone. For example, the first and second antenna element may be positioned at a maximal distance from other electronic components of the hearing device so as to minimize electromagnetic interference with these other components. Further, when the first and second antenna element are implemented as conductor traces on a flexible PCB, the respective parts of the PCB carrying the arm portions of the first antenna element and the ends of the second antenna element may be folded by an angle of 80 to 100 degrees relative to the part of the PCB carrying the central portion of the first antenna element.

A “hearing device” as used hereinafter is any ear level element suitable for reproducing sound by stimulating a user's hearing, such as an electroacoustic hearing aid, a bone conduction hearing aid, an active hearing protection device, a hearing prostheses element such as a cochlear implant, a wireless headset, an earbud, an earplug, an earphone, etc.

An “unfolded condition” of a foldable antenna as used hereinafter means that the antenna has been brought into a planar geometric condition.

A “transverse direction” of an antenna as used hereinafter designates a direction which is in the plane defined by the antenna in its unfolded condition and which is perpendicular to the central portion of the first and second antenna element.

A “longitudinal direction” of an antenna as used hereinafter designates a direction which is in the plane defined by the antenna in its unfolded condition and which is perpendicular to the transverse direction of the antenna.

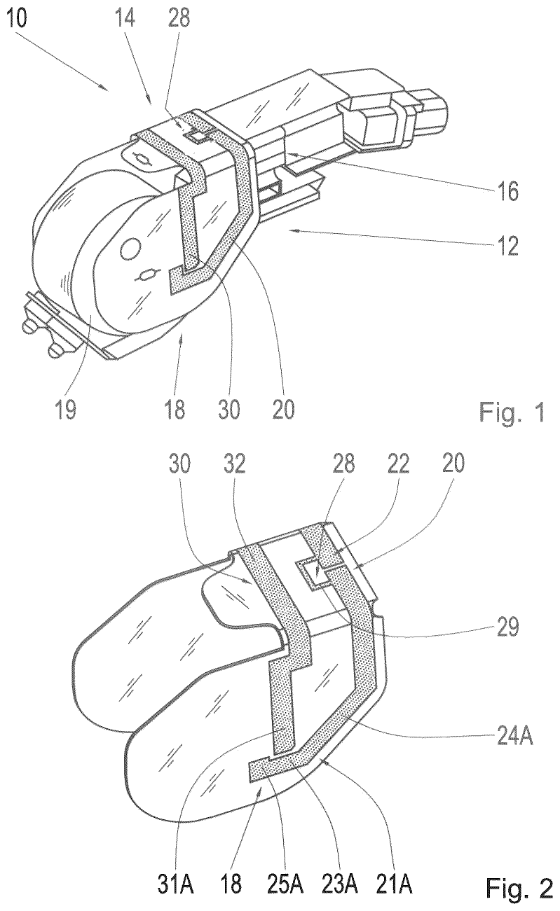

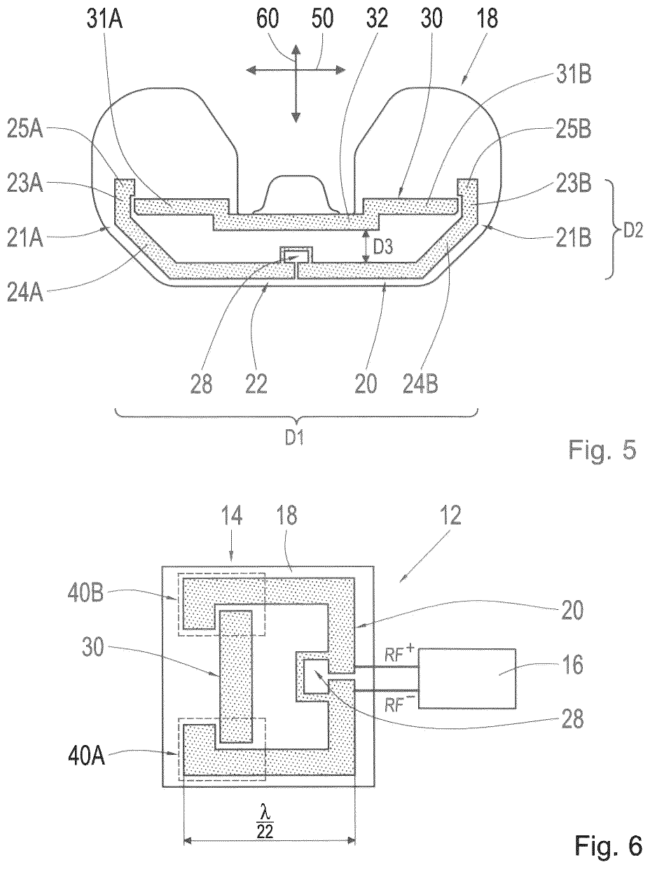

An example of a BTE hearing device 10 comprising a transmission system 12 including an antenna 14 and an RF (radio frequency) transceiver 16 is shown in FIG. 1, with the antenna 14 being shown FIGS. 2 to 5 in more detail, wherein FIG. 5 shows an unfolded condition of the antenna 14.

The antenna 14 is implemented as conductor traces on a flexible PCB (printed circuit board) 18 and comprises a U-shaped first antenna element 20 and a substantially strip-shaped second antenna element 30. The first antenna element 20 comprises a first arm portion 21A and a second arm portion 21B connected by a central portion 22, each arm portion 21A, 21B comprising a free end portion 23A, 23B. The second antenna 30 element extends in a transverse direction 50 (see in particular FIG. 5) between the free end portion 23A of the first arm portion 21A and the free end portion 23B of the second arm portion 21B and has a first end 31A coupled to the free end portion 23A of the first arm portion 21A via a first capacitive region 40A and a second end 31B coupled to the free end portion 23B of the second arm portion 21B via a second capacitive region 40B. The ends 31A, 31B of the second antenna element 30 are connected by a central portion 32.

The transceiver 16 is connected to the central portion 22 for feeding an RF signal to the first antenna element 20. The transceiver 16 may be configured to operate in the 2.4 GHz ISM band.

Both the first antenna element 20 and the second antenna element 30 may be implemented by a continuous conductor trace without interruptions. The conductor traces forming the first antenna element 20 and the second antenna element 30 may have a thickness between 12 and 70 μm and a width between 0.5 and 1.5 mm.

In the example of FIGS. 1 to 5 the PCB 18 is a flexible PCB, wherein the respective parts of the PCB carrying the arm portions 21A, 21B of the first antenna element 20 and the ends 31A, 31B of the second antenna element 30 are folded by an angle of about 90 degrees (e.g., 80 to 100 degrees) relative to the part of the PCB 18 carrying the central portion 22 of the first antenna element 20 and the central portion 32 of the second antenna element 30. Due to the folding of the PCB 18 a particularly compact antenna design is achieved, wherein the parts of the PCB 18 carrying the arm portions 21A, 21B of the first antenna element 20 and the ends 31A, 31B of the second antenna element 30 are oriented substantially parallel to each other. In particular, the folding allows the antenna to conform to the geometry of the battery 19 of the hearing device 10.

The following discussion of the geometry of the antenna 14—unless indicated to the contrary—relates to the unfolded condition of the antenna 14, as illustrated in particular in FIG. 5.

Each arm portion 21A, 21B of the first antenna element 20 includes an intermediate portion 24A, 24B which extends between the central portion 22 and the free end portion 23A, 23B and which is angled, e.g. at an angle of 30 to 60 degrees, relative to the central portion 22 and, at an appropriate angle relative to the free end portions 23A, 23B in such a way that the free end portions 23A, 23B are oriented substantially parallel to each other and substantially perpendicular to the central portion 22.

The central portion 22 of the first antenna element may have a length of 12 to 20 mm, and it may be oriented substantially parallel to the second antenna element 30. The distance D3 between the central portion 22 of the first antenna element 20 and the central portion 32 of the second antenna element 30 may be from 1 to 3 mm in a longitudinal direction 60 (see in particular FIG. 5) which is perpendicular to the transverse direction 50. It is to be understood that the distance D3 has to be selected such that the central portion 32 of the second antenna element 30 does not intersect with the shorting strip 29 of the first antenna element 20.

In the example of FIGS. 1 to 5 the central portion 32 of the second antenna element 30 is offset in the longitudinal direction 60, such as by 0.5 to 1.5 mm, with regard to the first end 31A and second end 31B of the second antenna element 30 towards the central portion 22 of the first antenna element 20. Such offset may depend on the shapes and positions of other components of the hearing device 10.

The distance D1 between the free end portions 23A, 23B of the arm portions 21A, 21B of the first antenna element 20 may be from 15 to 25 mm in the transverse direction 50 (when considering the first antenna element in the unfolded planar condition shown in FIG. 5), and a dimension D2 of the first antenna element 20 in the longitudinal direction 60 (i.e., a distance between the longitudinal edge of the central portion 22 and longitudinal edge of the free end portions 23A, 23B) may be from 3 to 7 mm.

The free end portions 23A, 23B of the first arm portion 21A and the second arm portion 21B, respectively, may have a length of 1.8 to 3.8 mm. The intermediate portions 24A, 24B of the first arm portion 21A and the second arm portion 21B, respectively, may have a length of 2.9 to 6.9 mm.

A ratio of the length of the second antenna element 30 (i.e., its dimension in the transverse direction 50) to the width of the second antenna element 30 (i.e., its dimension in the longitudinal direction 60) may be from 5 to 25. For example, the length of the second antenna element 30 may be from 15 to 25 mm, and the width of the second antenna element 30 may be from 1.0 to 3.0 mm.

An example of the capacitive region 40A is shown in detail in FIG. 4, wherein the width W of each arm portion 21A, 21B increases at its free end 23A, 23B so as to provide for a projection 25A, 25B facing the free end portion 23B, 23A of the other arm portion 21B, 21A, thereby forming a corner region 41A, 41B at each free end portion 23A, 23B. For example, each of the projections 25A, 25B may extend by 0.10 to 0.50 mm from the respective arm portion 21A, 21B into the transverse direction 50 towards the other arm portion 21B, 21A (this dimension of the projection 41A is labelled “W1” in FIG. 4).

The first end 31A of the second antenna element 30 extends in the transverse direction 50 into the corner region 41A formed at the free end portion 23A of the first arm portion 21A, thereby forming the first capacitive region 40A, and the second end 31B of the second antenna element 30 extends in the transverse direction 50 into the corner region 41B formed at the free end portion 23B of the second arm portion 21B, thereby forming the second capacitive region 40B. While in the example shown in FIG. 4 the ends 31A, 31B extend only very slightly into the respective corner region 41A, 41B, they may extend farther into to the respective corner region 41A, 41B, depending on the dimension W1.

A width C1 of a gap formed between the free end portion 23A of the first arm portion 21A and the first end 31A of the second antenna portion 30 and a width C1 of a gap formed between the free end portion 23B of the second arm portion 21B and the second end 31B of the second antenna portion 30, respectively, may be from 0.17 to 0.37 mm in the transverse direction 50.

A width C2 of a gap formed between the free end portion 23A of the first arm portion 21A and the first end 31A of the second antenna portion 30 and a width C2 of a gap formed between the free end portion 23B of the second arm portion 21B and the second end 31B of the second antenna portion 30, respectively, may be from 0.07 to 0.27 mm in the longitudinal direction 60.

In the example shown in FIG. 4 a chamfered corner 34A of the first end 31A of the second antenna element 30 facing the intermediate portion 24A of the first arm portion 21A is cut away along a line substantially parallel to the intermediate portion 24A of the first arm portion 21A, and a chamfered corner 34B of the second end 31B of the second antenna element 30 facing the intermediate portion 24B of the second arm portion 21B is cut away along a line substantially parallel to the intermediate portion 24B of the second arm portion 21B.

A width C3 of a gap between the chamfered corner 34A of the first end 31A of the second antenna element 30 and the intermediate portion 24A of the first arm portion 21A and a width of a gap between the chamfered corner 34B of the second end 31B of the second antenna element 30 and the intermediate portion 24B of the second arm portion 21B, respectively, may be from 0.33 to 0.63 mm.

Due to its coupling to the driven first antenna element 20 via the capacitive regions 40A, 40B the second antenna element 30 acts as a parasitic capacitive load in the near field of the first antenna element, e.g. serving to enlarge the electrical length of the antenna 14 so that it resonates in the 2.4 GHz band despite its relatively short physical length. In particular, the gap widths C1, C2 and C3, the dimension W1 of the projections 25A, 25B, the width of the end portions 31A, 31B of the second antenna element 30 and the degree to which the chamfered corners 34A, 34B are cut away may be varied to tailor the respective capacitive region 40A, 40B in a manner so as to achieve the desired resonance properties of the antenna 14.

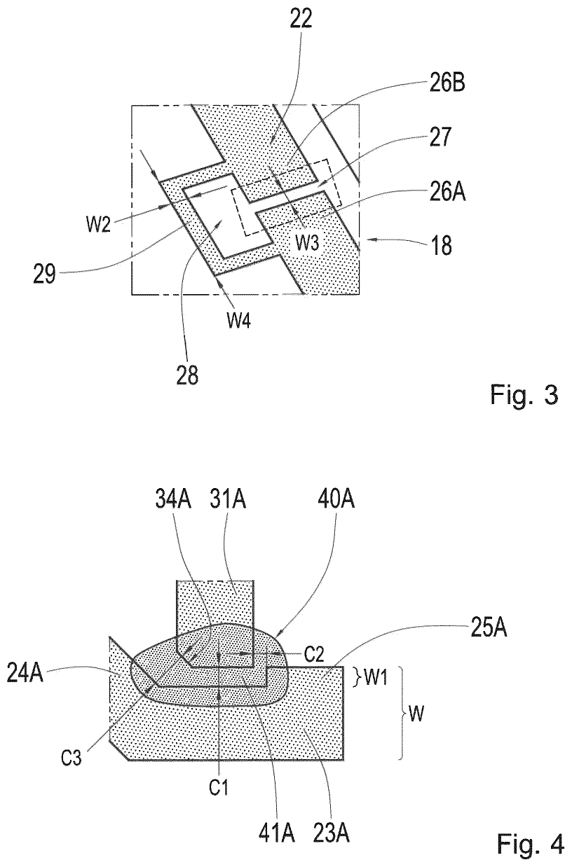

As shown in FIGS. 1 to 5, in particular in FIG. 3, the central portion 22 of the first antenna element 20 comprises two feeding points 26A, 26B, separated by a gap 27, for feeding a differential RF signal as the RF signal to the first antenna element 20. Further, the central portion 22 comprises an inductive region 28 formed by a shorting strip 29 which shorts the gap 27 formed in the central portion between the two feeding points 26A, 26B. In particular, the shorting strip 29 may be substantially arc-shaped, with a length W4 of 0.5 to 4.0 mm, e.g., 1.0 to 2.0 mm, and it may have a width W2 between 0.1 and 1.0 mm, e.g., 0.2 and 0.4 mm. The gap 27 formed in central portion 22 may have a width W3 of 0.5 to 1.5 mm.

The inductive region 28 acts as an inductive load can be used to match the antenna 14 to the desired impedance, e.g. 100 Ohm, and to the desired frequency. The geometry of the inductive region 28, in particular the width, length and thickness of the shorting strip 29, may be specifically tailored to this end.

FIG. 6 provides for a schematic illustration of a more general principle underlying the example of the antenna FIG. 5, wherein the first antenna element 20 and the second antenna element 30 are illustrated in a simplified manner.

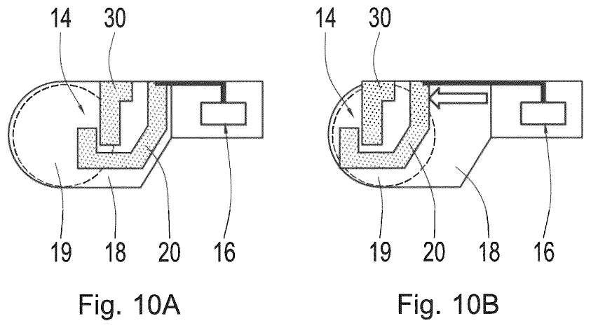

The first and second antenna element 20, 30 may be positioned at a maximal distance from other electronic components of the hearing device so as to minimize electromagnetic interference with these other components. Thanks to the compact antenna size, it is possible to modify the antenna position inside the hearing device module. Such flexibility in positioning the antenna inside the hearing device can be helpful to minimize the interference between the antenna and the neighboring electronic components. FIGS. 10A and 10B shows schematic view of possible antenna positions. In FIG. 10A, the antenna 14 is placed close to the RF transceiver 16. In this context, the antenna could be susceptible to interference from the RF environment and vice-versa. On the other hand, due to the compact antenna size, it may be possible to integrate the antenna 14 in a position farther away from the RF transceiver 16 in order to reduce the interference with its electromagnetic environment, as illustrated in FIG. 10B. It is noted that when the antenna position is modified, parametric tuning might be required to achieve the desired impedance response.

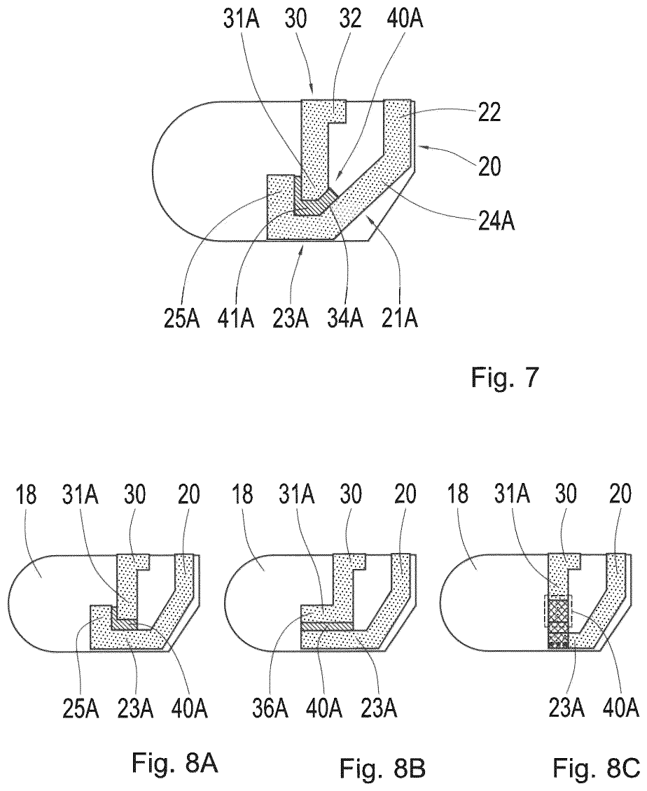

In FIG. 7 a variant of the example of the capacitive region 40A of FIG. 4 is illustrated, wherein the projection 25A is more pronounced, i.e., it extends farther away from the first arm portion 21A in the transverse direction 50, and wherein the first end 31A of the second antenna element extends “deeper” into the corner region 41A, thereby changing the electric properties of the capacity region 40A.

FIGS. 8A to 8C illustrate other variants of the geometry of the capacity region 40A.

In FIG. 8A a further variant of the example of FIG. 5 is shown, wherein none of the corners of the end portion 31A of the second antenna element 30 is chamfered.

In FIG. 8B an example is shown, wherein no projection is provided at the free end portion 23A; rather, an elongate rectangular gap oriented substantially in the longitudinal direction 60 is provided by providing the first end 31A of the second antenna element 30 with an extension 36A in the longitudinal direction.

In FIG. 8C an example is shown, wherein the gap in the capacitive region is not provided as horizontal gap extending in a common plane of the first antenna element 20 and the second antenna element 30, but rather is provided as gap extending in a vertical direction normal to the PCB. To achieve this, one of the free end portion 23A of the first arm portion 21A and the first end 31A of the second antenna portion 30 is elevated relative to the other, with the free end portion 23A of the first arm portion 21A and the first end 31A of the second antenna portion 30 defining an overlap region with a plate-like gap forming the first capacitive region 40A, and wherein one of the free end portion 23B of the second arm portion 21B and the second end 31B of the second antenna portion 30 is elevated relative to the other, with the free end portion 23B of the second arm portion 21B and the second end 31B of the second antenna portion 30 defining an overlap region 44B with a plate-like gap 44B forming the second capacitive region 40B. For example, the first antenna element 20 and the second antenna element 30 could be implemented in different vertical layers of the PCB 18.

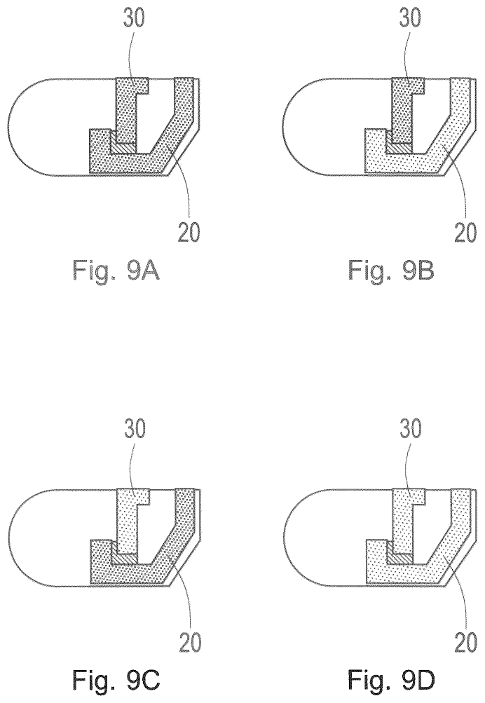

In FIGS. 9A to 9D several variants of how the first antenna element 20 and the second antenna element 30 may be implemented on a PCB and/or a housing are illustrated schematically.

FIG. 9A illustrates the case discussed so far wherein both the first antenna element 20 and the second antenna element 30 are implemented as conductor traces on a PCB. It is to be noted that the first antenna element 20 and the second antenna element 30 could be implanted in the same layer of the PCB or in (vertically) different layers of the PCB.

FIG. 9C illustrates a case wherein the first antenna element 20 is implemented as a conductor trace on a PCB, while the second antenna element 30 is implemented as a conductor trace on the housing of the electronic device, e.g. by printing on the housing, such as by Laser Direct Structuring.

FIG. 9B illustrates a case wherein the second antenna element 30 is implemented as a conductor trace on a PCB, while the first antenna element 20 is implemented as a conductor trace on the housing of the electronic device, e.g. by printing on the housing, such as by Laser Direct Structuring.

FIG. 9D illustrates a case wherein both the first antenna element 20 and the second antenna element 30 are implemented as a conductor trace on the housing of the electronic device, e.g. by printing on the housing, such as by Laser Direct Structuring.

The above described antenna concept provides for an ultra-compact antenna with a U-shaped first element reactively coupled with a second element acting as parasitic strip to achieve an efficient radiation performance, in particular in the 2.4 GHz ISM band. The capacitive loads formed by the second antenna element serve in enlarging the electrical length of the antenna so that it resonates e.g. in the 2.4 GHz ISM band. In addition, impedance matching of the antenna may be achieved by adding a shorting strip at the level of the feeding point of the first element. This strip acts as an inductive load that accordingly modifies the input impedance of the antenna in order to achieve the desired matching to the source impedance (for example, Z₀=100 Ohm) in the frequency band of interest.

This antenna concept is suitable for body worn electronic devices, in particular hearing devices, such ITE (in the ear), RIC (receiver in the canal), BTE (behind the ear) hearing devices or sound processors of cochlear implants, wireless headsets, earbuds, earplugs, and earphones.

What is claimed is:

1. A transmission system for a body-worn electronic device, comprising:
a U-shaped first antenna element comprising a first arm portion and a second arm portion connected by a central portion configured to be connected to a transceiver for feeding an RF signal to the first antenna element, each arm portion comprising a free end portion; and
a second antenna element extending in a transverse direction between the free end portion of the first arm portion and the free end portion of the second arm portion, the second antenna element having a first end coupled to the free end portion of the first arm portion via a first capacitive region, and having a second end coupled to the free end portion of the second arm portion via a second capacitive region.

2. The transmission system of claim 1, wherein the first antenna element and the second antenna element are implemented as conductor traces on a PCB.

3. The transmission system of claim 2, wherein the PCB is a flexible PCB and wherein the respective parts of the PCB carrying the arm portions of the first antenna element and the ends of the second antenna element are configured to be folded by an angle of 80 to 100 degrees relative to the part of the PCB carrying the central portion of the first antenna element.

4. The transmission system of claim 1, wherein the width of each arm portion increases at its free end portion so as to provide for a projection facing the free end portion of the other arm portion, thereby forming a corner region at each free end portion.

5. The transmission system of claim 1, wherein each arm portion of the first antenna element includes an intermediate portion which extends between the central portion and the free end portion and which is angled, such as at an angle of 30 to 60 degrees, relative to the central portion, and wherein the free end portions are oriented substantially parallel to each other and substantially perpendicular to the central portion.

6. The transmission system of claim 5, wherein a corner of the first end of the second antenna element facing the intermediate portion of the first arm portion is cut away, and wherein a corner of the second end of the second antenna element facing the intermediate portion of the second arm portion is cut away.

7. The transmission system of claim 6, wherein the corner of the first end of the second antenna element facing the intermediate portion of the first arm portion is cut away along a line substantially parallel to the intermediate portion of the first arm portion, and wherein the corner of the second end of the second antenna element facing the intermediate portion of the second arm portion is cut away along a line substantially parallel to the intermediate portion of the second arm portion.

8. The transmission system of claim 1, wherein the central portion of the first antenna element is oriented substantially parallel to the second antenna element.

9. The transmission system of claim 1, wherein the central portion of the first antenna element comprises two feeding points, separated by a gap, for feeding a differential RF signal as said RF signal to the first antenna element.

10. The transmission system of claim 9, wherein the central portion of the first antenna element comprises an inductive region formed by a shorting strip which shorts the gap formed in the central portion between the two feeding points.

11. The transmission system of claim 1, wherein the second antenna element is designed to act as a capacitive load.

12. The transmission system of claim 1, wherein the second antenna element is substantially strip-shaped.

13. The transmission system of claim 1, further comprising a transceiver connected to the central portion for feeding an RF signal to the first antenna element.

14. A hearing device comprising a transmission system of claim 1.
